(19) United States
(12) Patent Application Publication
(10) Pub. No.: US 2025/0291668 A1
(43) Pub. Date: Sep. 18, 2025

(54) INFORMATION PROCESSING DEVICE

(71) Applicant: TOYOTA JIDOSHA KABUSHIKI KAISHA, Toyota-shi (JP)

(72) Inventors: Toshiaki TAMACHI, Seto-shi (JP); Hideaki BUNAZAWA, Tokyo (JP); Koichi OKUDA, Toyota-shi (JP); Atsushi TABATA, Okazaki-shi (JP)

(73) Assignee: TOYOTA JIDOSHA KABUSHIKI KAISHA, Toyota-shi (JP)

(21) Appl. No.: 19/033,502

(22) Filed: Jan. 22, 2025

(30) Foreign Application Priority Data
Mar. 15, 2024 (JP) 2024-041261

(51) Int. Cl. G06F 11/07

(52) U.S. Cl. CPC G06F 11/079; G06F 11/0721

(57) ABSTRACT

The processing device of the information processing device includes: a first step of calculating a relative frequency distribution of target data excluding data of an initial prescribed period from the original data; a second step of setting a plurality of time windows for cutting out data of a part of the period of the target data; a third step of cutting out data from the target data; a fourth step of calculating a relative frequency distribution in the extracted data; and a fifth step of calculating an error between the relative frequency distribution of the target data and the relative frequency distribution of the extracted data; and a search process of repeatedly executing the trial from the second step to the fifth step by changing the setting of the plurality of time windows.

### CROSS-REFERENCE TO RELATED APPLICATION

This application claims priority to Japanese Patent Application No. 2024-041261 filed on Mar. 15, 2024, incorporated herein by reference in its entirety.

### BACKGROUND

### 1. Technical Field

The present disclosure relates to an information processing device.

### 2. Description of Related Art

Japanese Unexamined Patent Application Publication No. 2008-108247 (JP 2008-108247 A) discloses an information processing device that reduces the size of data for analysis by compressing original data for analysis. The original data for analysis are data collected over a predetermined period using a sensor mounted on a vehicle.

The information processing device disclosed in JP 2008-108247 A compresses data by extracting, from the original data, data acquired at the time when a certain vehicle speed is reached and data acquired at the time of an inflection point of the vehicle speed.

### SUMMARY

The above information processing device extracts data by focusing only on the vehicle speed. Therefore, the above information processing device cannot extract data according to characteristics of data other than the vehicle speed. There is a demand for an information processing device capable of obtaining extracted data that capture characteristics of the original data including a plurality of feature quantities.

In order to address the above issue, an aspect provides an information processing device that reduces an amount of data to be used for analysis by extracting a part of data from original data collected over a predetermined period using a plurality of sensors mounted on a vehicle. The information processing device includes a processing device that executes a process. In the information processing device, the processing device executes a search process including a first step of calculating relative frequency distribution in object data obtained by excluding data for an initial prescribed period from the original data about a plurality of feature quantities included in the original data for each feature quantity. The search process includes a second step of setting a plurality of time windows for cutting out data for a part of a period of the object data such that a period obtained by totaling periods of all the time windows is shorter than an object period obtained by excluding the initial prescribed period from the predetermined period. The search process includes a third step of cutting out data from the object data using the time windows. The search process includes a fourth step of calculating relative frequency distribution in extracted data obtained by combining the data cut out using the time windows for each feature quantity. The search process includes a fifth step of calculating an error between the relative frequency distribution in the object data and the relative frequency distribution in the extracted data. The processing device extracts the extracted data whose error is equal to or less than a threshold by executing the first step and thereafter repeatedly making trials to execute the second step to the fifth step while changing settings of the time windows.

In one aspect of the information processing device, the processing device may execute clustering that is machine learning to classify data in sections obtained by dividing the object data for each certain period into a predetermined number of clusters. The processing device may set the time windows in the second step such that a difference between a ratio of each cluster in the extracted data and a ratio of each cluster in the entire object data is equal to or less than a threshold.

The information processing device can obtain extracted data that capture characteristics of original data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing device;

FIG. 2A is a graphic showing the original data, and shows the transition of oil flow rate;

FIG. 2B is a graphical representation of the original data, and shows the transition of the speed change frequency;

FIG. 3 is a flowchart illustrating a flow of processing executed by the processing device of the data center;

FIG. 4 is a graph illustrating an example of clustering target data using two feature amounts;

FIG. 5 is a graph illustrating an example of a relative frequency distribution for a flow rate of oil in target data;

FIG. 6 is a graph illustrating an example of the relative frequency distribution of the shift frequency in the target data; and

FIG. 7 is a graph illustrating an example of a relationship between an index value and a traveling time.

### DETAILED DESCRIPTION OF EMBODIMENTS

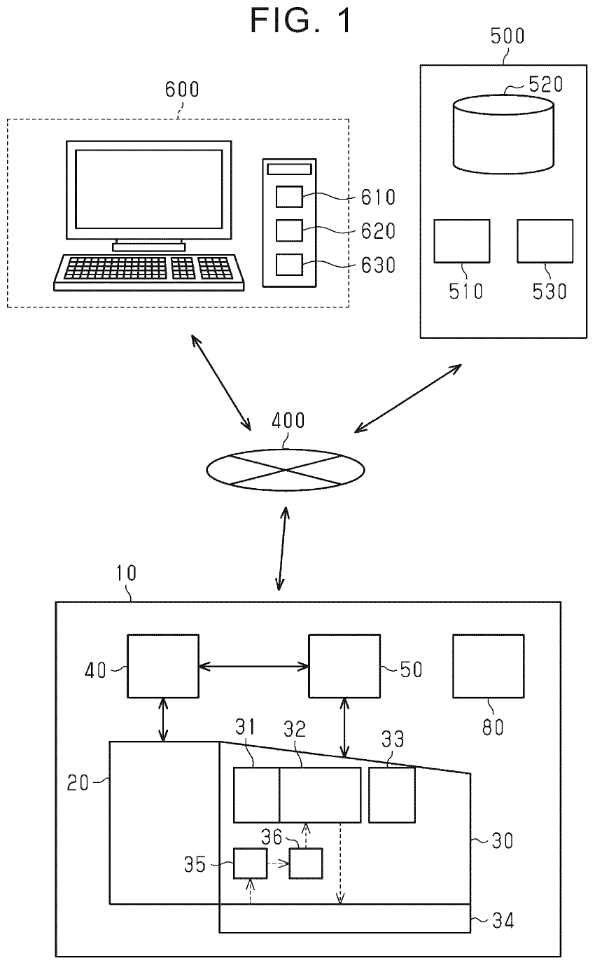

Hereinafter, a data center 500, which is an embodiment of an information processing device, will be described with reference to FIGS. 1 to 7.

### Configuration of Information Processing System

FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of the Data Center 500

As illustrated in FIG. 1, the data center 500 includes a processing device 510. The data center 500 includes a storage device 520 and a communication device 530. The processing device 510 includes a CPU that executes processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

The data center 500 may be configured using a plurality of computers. For example, the data center 500 can be composed of multiple server devices.

### Configuration of the Vehicle 10

Each of the plurality of vehicles 10 includes a communication device 80. The communication devices 80 are implemented as hardware such as a network adapter, various communication software, or a combination thereof. These communication devices 80 are configured to realize wired or wireless communication via the communication network 400.

Each vehicle 10 is equipped with an engine 20 and an automatic transmission 30. For example, the automatic transmission 30 is a planetary gear type transmission. The automatic transmission 30 includes a friction engagement device 31, a planetary gear train 32, and a hydraulic control circuit 33. The friction engagement device 31 alters the combination of planetary gear trains 32 that transmit power by engaging or releasing a plurality of frictional engagement elements. Accordingly, the automatic transmission 30 forms a plurality of transmission stages having different gear ratios. The frictional engagement element is, for example, a clutch or a brake. The hydraulic control circuit 33 controls the hydraulic pressure supplied to the respective frictional engagement elements of the friction engagement device 31.

The automatic transmission 30 includes an oil pan 34, a pump 35, and an oil filter 36. The pump 35 sucks the oil stored in the oil pan 34 and supplies the oil to the planetary gear train 32 via the oil filter 36. The oil recovered from the planetary gear train 32 is stored in the oil pan 34 again.

The vehicle 10 includes an engine control device 40 and a transmission control device 50. The engine control device 40 controls the engine 20. The transmission control device 50 controls the automatic transmission 30 by controlling the hydraulic control circuit 33. The transmission control device 50 supplies oil to the planetary gear train 32 by controlling the pump 35.

The engine control device 40 and the transmission control device 50 are equipped with various sensors that collect information on each part of the vehicle 10. In each vehicle 10, travel data is collected from the various sensors. The traveling data is transmitted from each vehicle 10 to the data center 500 by the communication device 80. For example, travel data including the travel distance, the position information, and the vehicle speed of each vehicle 10 is transmitted from each vehicle 10 to the data center 500. The travel data also includes various data indicating the state of the automatic transmission 30 acquired by the transmission control device 50 of the vehicle 10. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500.

### Configuration of the Information Processing Terminal 600

The information processing terminal 600 includes a processing device 610, a storage device 620, and a communication device 630. The processing device 610 includes a CPU that executes processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of the Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the oil filter 36 of the specific vehicle 10 based on the traveling data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the original data from a large amount of travel data that is the original data. If such extracted data can be extracted, the processing device 510 can perform analysis in a shorter time by using the extracted data.

Here, among the original data collected over the predetermined period P, the initial data of the initial prescribed period P0 is more likely to be influenced by the initial causes shared by the respective vehicles 10 than the actual driving conditions that may be different for the respective vehicles 10. The initial data differs from the data in the period other than the initial prescribed period P0 in the tendency. For example, the initial prescribed period P0 is a period from the manufacturing of the vehicles 10 until a predetermined traveling time elapses. It is known that, in the initial prescribed period P0, damage is more likely to accumulate in the oil filter 36 due to, for example, foreign matter from the planetary gear train 32 and the oil pan 34 than in a period other than the initial prescribed period P0. Therefore, it is conceivable to extract extracted data from the original data by excluding the data of an initial prescribed period P0. Of the predetermined period P, the period excluding the initial prescribed period P0 becomes the object period P1.

For example, when estimating the damage of the oil filter 36 when the vehicle travels for 100100 hours, the processing device 510 sets the data obtained by excluding the initial data of 100 hours corresponding to the initial prescribed period P0 from the original data of 100100 hours as the target data. The processing device 510 estimates the damage using the extracted data for 20000 hours extracted from the target data for 0.1 million hours. The processing device 510 multiplies the index value calculated from the extracted data for 20000 hours by 5 to calculate the index value of the damage of the oil filter 36 when the vehicle travels for 0.1 million hours. The processing device 510 calculates an index value of damage of the oil filter 36 using all of the initial data for 100 hours. Then, the processing device 510 calculates the index value of the damage of the oil filter 36 when the vehicle travels for 100100 hours by adding the index value of the damage calculated based on the target data and the index value of the damage calculated based on the initial data.

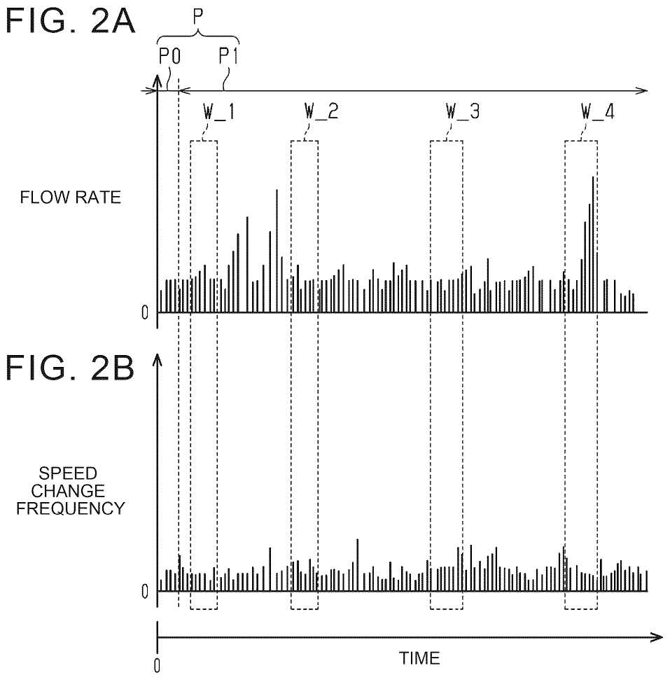

FIGS. 2A and 2B show exemplary original-data. The original data shown in FIGS. 2A and 2B is travel data for 100100 hours in one vehicle 10. The original data shown in FIGS. 2A and 2B includes, as characteristic quantities, a flow rate of oil passing through the oil filter 36 to be subjected to calculation of an index value of damage, and a shift frequency of the automatic transmission 30.

FIG. 2A shows the transition of the flow rate of the oil for 100100 hours. The flow rate of the oil can be detected by a flow rate sensor mounted on the vehicle 10. The flow rate of the oil may be calculated by the transmission control device 50. For example, the flow rate of the oil may be a discharge amount calculated from the standard of the pump 35, the number of revolutions, and the like.

FIG. 2B shows the transition of the shift frequency of the automatic transmission 30 for 100100 hours. The shift frequency indicates the number of times the gear ratio is changed per fixed time. The transmission control device 50 calculates the shift frequency. The data in which the timing when the gear ratio is changed is recorded from the vehicle 10 may be transmitted to the data center 500, and the speed change frequency may be calculated in the data center 500. The shift frequency may be data indicating an execution interval of engagement using the same frictional engagement element.

The oil flow rate and the speed change frequency correlate with the damage of the oil filter 36 of the vehicle 10. The processing device 510 of the data center 500 estimates the damage of the oil filter 36 from the traveling data including the flow rate of the oil and the speed change frequency as the feature amount.

The extracted data is created by extracting data from the target data excluding the data of the initial prescribed period P0 from the original data by using a plurality of temporal windows. In FIGS. 2A and 2B, four time windows of the first time window W_1, the second time window W_2, the third time window W_3, and the fourth time window W_4 are indicated by broken lines, respectively, as the plurality of time windows. The beginning and end of each time window are set such that the respective time windows do not overlap. The start time and the end time of the respective time-windows are both set to the object period P1. In this example, the traveling data for 20000 hours is extracted as the extracted data. Therefore, the start and end periods of each time window are set so that the total length of the time periods of all the time windows is 20000 hours.

The data center 500 searches for the setting of the start time and the end time of each time window indicating the cut-out pattern for extracting the extracted data in which the feature of the original data is captured.

The data center 500 extracts the extracted data from the target data using the cut-out pattern found by the search. The data center 500 performs analysis using the extracted data.

### Searching for Cut Patterns

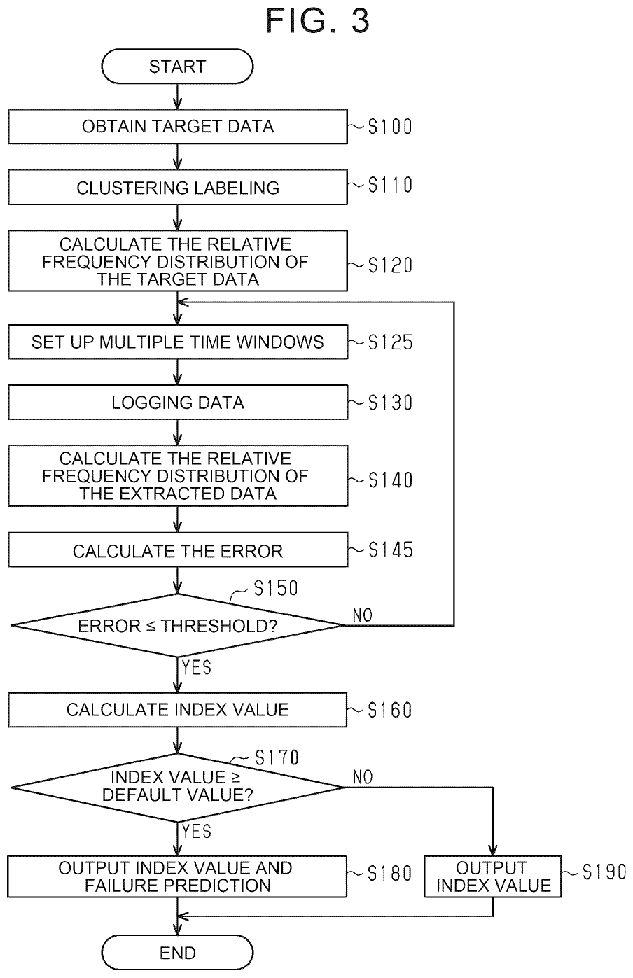

FIG. 3 is a flowchart illustrating a flow of a series of processes related to the extraction pattern search process. This series of processing is executed by the processing device 510 of the data center 500.

As illustrated in FIG. 3, the processing device 510 acquires the target data in S100 processing. For example, the processing device 510 acquires a part of the travel data as original data in accordance with the purpose of analysis from the enormous travel data stored in the storage device 520 of the data center 500. For example, the original data for calculating the index value indicating the magnitude of the damage accumulated in the oil filter 36 of one vehicle 10 is the travel data for the predetermined period P of the target vehicle 10 selected from the huge travel data of the plurality of vehicles 10. Then, the processing device 510 sets, as target data, data obtained by excluding initial data of an initial prescribed period P0 from the acquired original data. For example, when estimating the damage of the oil filter 36 when the vehicle travels for 100100 hours, the target data is travel data over the object period P1 of the target vehicle 10 excluding the initial data of 100 hours corresponding to the initial prescribed period P0.

In S110 process, the processing device 510 labels the target data by clustering. Specifically, the processing device 510 divides the target data at regular intervals. The length of the period for separating the target data is, for example, several minutes. Then, the processing device 510 executes clustering which is machine learning for classifying the data of each section into a predetermined number of clusters. For example, k-means method is used as the algorithm of clustering. k-means method is a clustering algorithm for classifying data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the target data can be classified into clusters of travel data having similar characteristics. The number of clusters to be classified is arbitrarily set according to the contents of the analysis.

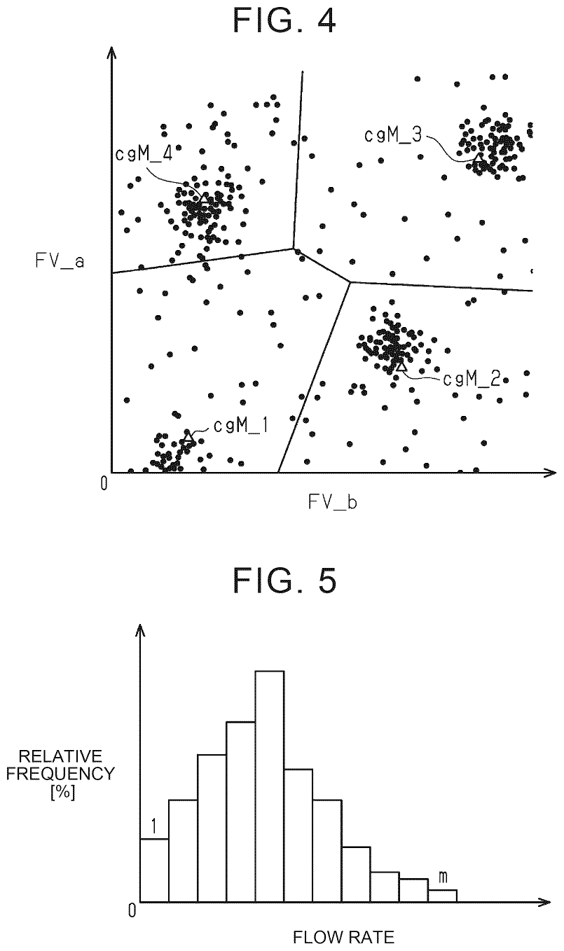

FIG. 4 is a graph illustrating an exemplary clustering of target data into four clusters by a k-means method using two feature amounts included in original data as explanatory variables. For example, the two characteristic quantities are the flow rate and the speed change frequency of the oil shown in FIGS. 2A and 2B. In FIG. 4, each piece of data in each section in which the target data is partitioned is indicated by one point. When performing clustering, the processing device 510 uses a representative value of an explanatory variable in the data of each section. For example, the processing device 510 sets the average value of the feature amounts in the data of each section as a representative value. The processing device 510 may use, as the representative value, the moving average value of the feature amounts in a plurality of consecutive sections in time series.

In FIG. 4, these points are shown in a two-dimensional space with the first feature amount FV_a and the second feature amount FV_b as coordinate axes. FIG. 4 is an example in which target data is clustered in four clusters of the first cluster M_1, the second cluster M_2, the third cluster M_3, and the fourth cluster M_4. In FIG. 4, the boundaries of the four clusters are indicated by solid lines. In FIG. 4, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 4 shows two examples of explanatory variables, the number of explanatory variables is not limited to two. For example, when the target data includes three feature amounts, the processing device 510 may perform clustering using these three feature amounts as explanatory variables. In this case, the processing device 510 clusters the target data in the three-dimensional coordinate space.

The processing device 510 assigns a label indicating the result of the clustering in this manner to the target data. Specifically, each data indicated by a point in the coordinate space is given a label for identifying a cluster in which the data is classified. In this way, the processing device 510 creates the target data to which the label is attached.

Next, in S120 process, the processing device 510 calculates the relative-frequency-distribution of the target-data. As described above, the original data and the target data include a plurality of feature amounts. The processing device 510 calculates a relative frequency distribution in the target data for each feature amount.

The frequency distribution classifies data into a plurality of classes, and represents a frequency distribution that is the number of data of each class. The relative frequency indicates how much the frequency of the class accounts for the sum of the total frequencies.

FIG. 5 shows the relative frequency distribution for the flow rate of oil in the target data. In this relative frequency distribution, the grades of the flow rate of the oil in the target data are divided into m grades from 1 to m, and the relative frequency distribution is shown.

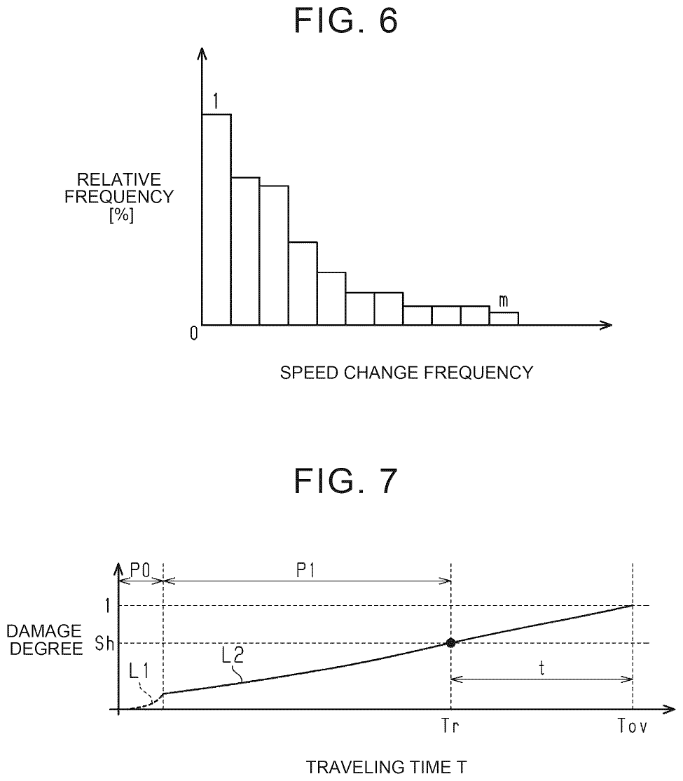

FIG. 6 shows the relative frequency distribution for the shift frequency in the target data. In this relative frequency distribution, the class of the shift frequency in the target data is divided into m classes from 1 to m, and the relative frequency distribution is shown.

In S120 process, the processing device 510 calculates the relative-frequency-distribution for the respective feature values included in the target data. The number of classes in the relative frequency distribution of each feature is the same.

For example, when the original data includes two characteristic quantities, i.e., the flow rate of oil and the shift frequency, as the characteristic quantities, as illustrated in FIGS. 2A and 2B, the processing device 510 calculates the relative frequency distributions of the two characteristic quantities for the target data.

Next, in S125 process, the processing device 510 sets a plurality of time-windows in order to extract extracted data from the target data. In FIGS. 2A and 2B, four time windows W_1 to W_4 of the first time window W_1, the second time window W_2, the third time window W_3, and the fourth time window W_4 are illustrated as exemplary time windows. In FIGS. 2A and 2B, the time-windows are all equal. As illustrated in FIGS. 2A and 2B, the data cut out by the respective cut-out windows is data of the respective feature amounts in the same time interval.

In S125 process, the processing device 510 randomly sets a plurality of time windows such that a period obtained by summing the periods of all the time windows is shorter than an object period P1 which is a period of the entire target data. As will be described later, the processing device 510 combines all the data cut out by the plurality of time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window each time S125 process is executed. At this time, the processing device 510 sets each time window so that each time window does not overlap. The processing device 510 sets the respective time windows within the object period P1. The processing device 510 thus randomly sets the plurality of time windows such that the total period of all time windows is a preset period. In S125 process, the processing device 510 may set a plurality of time windows by fixing the time periods of the respective time windows to be constant, as illustrated in FIGS. 2A and 2B. In S125 process, the processing device 510 may fix the plurality of time windows to a fixed number and set the plurality of time windows.

In addition to the above-described requirements, when setting a plurality of time windows through S125, the processing device 510 sets a plurality of time windows such that a difference between a ratio of each cluster in the extracted data and a ratio of each cluster in the entire target data is equal to or less than a threshold.

In this way, by setting a plurality of time-windows through S125 process, a cut-out pattern in which data is cut out from the target data is determined. When the processing device 510 determines the cut-out pattern in this way, the processing proceeds to S130.

In S130 process, the processing device 510 cuts out data from the target data in the determined cutout pattern. That is, in S130 process, the processing device 510 cuts out data from the target data by a plurality of set time-windows. Then, the processing device 510 combines all the data cut out by the plurality of time windows to create extracted data.

In the following S140 process, the processing device 510 calculates the relative-frequency distribution of the extracted data. The processing device 510 calculates the relative frequency distribution of the extracted data in the same manner as the method of calculating the relative frequency distribution in S120. In other words, in S140 process, the processing device 510 calculates the relative-frequency distribution of the extracted data for each feature value. At this time, the processing device 510 sets the number of grades in the relative frequency distribution of the respective feature amounts to be the same as the relative frequency distribution in S120.

For example, when the original data includes two characteristic quantities, i.e., the flow rate of oil and the shift frequency, as the characteristic quantities, as illustrated in FIGS. 2A and 2B, the processing device 510 calculates the relative frequency distributions of the two characteristic quantities with respect to the target data even in S140.

Next, in S145 process, the processing device 510 calculates an error between the relative frequency distribution in the target data and the relative frequency distribution in the extracted data. For example, the processing device 510 calculates a mean absolute error (MAE). The mean absolute error MAE is expressed by the following equation.

$$MAE = \frac{1}{n} {\sum }_{i = 1}^{n} {\sum }_{j = 1}^{m} \vert {Y}_{n m} - {y}_{n m} \vert \qquad Mathematical formula 1$$

In the above equation, “n” is the number of feature quantities. “m” is the number of series in the relative frequency distribution. “Y” is the frequency of the corresponding feature amount in the target data in the corresponding class. “y” is the frequency of the corresponding feature amount in the extracted data in the corresponding class.

As shown in the above equation, the processing device 510 calculates the sum of the errors of the frequencies in the respective classes for each feature amount of the relative frequency distribution in the entire target data and the relative frequency distribution in the extracted data as an error.

After calculating the error, the processing device 510 advances the processing to S150. In S150 process, the processing device 510 determines whether or not the calculated error is less than or equal to the thresholds. The threshold value is a value for determining whether or not the extracted data having the relative frequency distribution close to the relative frequency distribution in the target data is extracted by the set cutout pattern. The magnitude of the threshold is set in advance so that it can be determined that the extracted data having the relative frequency distribution close to the relative frequency distribution in the target data is extracted based on the error being equal to or smaller than the threshold.

In S150 process, when it is determined that the error is equal to or smaller than the threshold (S150: YES), the processing device 510 advances the process to S160. In S160 process, the processing device 510 calculates the target index using the extracted data created in the most recent S130 process and the initial data excluded from the original data when the extracted data is created. Here, an index value indicating the magnitude of the damage accumulated in the oil filter 36 is calculated. For example, the processing device 510 calculates the damage degree Sh as an index indicating the degree of damage accumulated in the oil filter 36.

The damage degree Sh is an index value representing a ratio of the accumulated damage, assuming that the damage of the oil filter 36 gradually accumulates, with the damage leading to the damage being “1”. Here, the damage applied to the oil filter 36 during a certain period of time is calculated from the flow rate of the oil and the speed change frequency. Then, the amount of damage that the oil filter 36 suffers from damage is set to “1”, and the calculated rate of damage is calculated as an index value. By repeating this, a damage degree Sh which is a ratio of accumulated damage to the calculated damage is calculated. When the damage degree Sh becomes “1”, the damage is caused, and the calculated damage degree Sh is a value from “0” to “1”.

Here, since the damage degree in the object period P1 is calculated using the extracted data which is a part of the target data, the processing device 510 converts the calculated damage degree into a size corresponding to the target data, and calculates the damage degree in the object period P1. For example, when the target data is traveling data for 0.1 million hours and the extracted data is traveling data for 20000 hours, the calculated damage degree is multiplied by 5 to obtain the damage degree in the object period P1. In addition, the processing device 510 calculates the damage degree in the initial prescribed period P0 using all of the initial data. Then, the processing device 510 adds the damage degree in the object period P1 and the damage degree in the initial prescribed period P0 to calculate the target damage degree Sh.

On the other hand, in S150 process, when it is determined that the error is larger than the threshold (S150: NO), the processing device 510 returns the process to S125. Then, the processing device 510 re-executes the search processing from S125 to S145.

In this way, the processing device 510 repeatedly executes the search processing of S125 to S145 by changing the settings of the plurality of time-windows, and extracts extracted data in which the error becomes equal to or less than the threshold value from the target data. Then, the processing device 510 calculates the index using the extracted data and the initial data over the initial prescribed period P0. After calculating the index, the processing device 510 advances the processing to S170.

In S170 process, the processing device 510 determines whether or not the index value is equal to or greater than a predetermined value. The default value is a value for predicting that damage is more likely to occur based on the fact that the index value is equal to or larger than the default value. For example, “0.9” can be set here, for example, as a default in the damage degree Sh. In this case, it is possible to predict that the possibility of the damage is high based on the fact that the damage has reached 90% of the damage leading to the damage.

In S170 process, when it is determined that the index value is equal to or greater than the predetermined value (S170: YES), the processing device 510 advances the process to S180. In S180 process, the processing device 510 outputs an index and a failure estimate. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs.

As illustrated in FIG. 7, for example, when the damage degree Sh calculated using the extracted data extracted from the target data for 0.1 million hours and the initial data for 100 hours is the index value, the processing device 510 calculates the remaining traveling time t until the damage degree Sh reaches “1”. The processing device 510 outputs the calculated remaining traveling time t as life information. The processing device 510 may convert the information on the life into the travel distance based on the travel distance of 100100 hours and output the converted information.

For example, the processing device 510 predicts the life of the oil filter 36 from the slope of the transition of the index value in the object period P1. The processing device 510 calculates the remaining traveling time t until the damage degree Sh reaches “1” by using an approximate straight line or an approximate curve calculated based on the plurality of data of the damage degree Sh and the traveling time T in the object period P1.

The approximate curve L1 indicated by the broken line is calculated based on a plurality of data of the damage degree Sh and the traveling time T in the initial prescribed period P0. The approximate curve L2 indicated by the solid line is calculated based on the plurality of data of the damage degree Sh and the traveling time T in the object period P1. For example, the processing device 510 calculates the damage degree Sh at predetermined intervals. The processing device 510 calculates an approximate curve based on the plurality of data of the damage degree Sh and the traveling time T for each predetermined period.

When the current Tr is the object period P1, the processing device 510 calculates, based on the damage degree Sh of the current Tr and the approximate curve L2, the remaining traveling time t up to the time Tov at which the damage degree Sh is predicted to reach “1” and outputs the calculated remaining traveling time t as life information. For example, the processing device 510 calculates the remaining traveling time t from the slope of the tangent line of the approximate curve L2 at the current Tr. The processing device 510 may calculate the remaining traveling time t from the mathematical expression of the approximate curve L2. The processing device 510 may calculate the remaining traveling time t from the slope of the approximate straight line or the mathematical expression of the approximate straight line. When the current Tr is the initial prescribed period P0, the processing device 510 may not calculate the remaining traveling time t.

In S170 process, when it is determined that the index value is less than the predetermined value (S170: NO), the processing device 510 advances the process to S190. In S190 process, the processing device 510 outputs an index. Specifically, the processing device 510 transmits the index value to the information processing terminal 600 that has transmitted the instruction for requesting the analysis.

When S180 or S190 process is executed, the processing device 510 terminates the series of processes.

### Operation of this Embodiment

The data center 500, which is the information processing device of the present embodiment, acquires original data collected and created over a predetermined period P by using a plurality of sensors mounted on the vehicle 10, and calculates an index value indicating the magnitude of damage accumulated in the oil filter 36.

The data center 500 includes a processing device 510 that executes processing. The original data includes data of the flow rate of the oil and data of the speed change frequency as feature amounts. The search process executed by the processing device 510 includes a first step (S120) of calculating, for each feature quantity, a relative frequency distribution in the target data obtained by excluding the data of the initial prescribed period P0 from the original data for the plurality of feature quantities included in the original data. The searching process includes a second step (S125) of setting a plurality of time windows for cutting out data of a part of the period of the target data such that a period in which the periods of all the time windows are summed is shorter than the object period P1. The search process includes a third step (S130) of extracting data from the target data by a plurality of temporal windows. The search process includes a fourth step (S140) of calculating, for each characteristic quantity, the relative frequency distribution in the extracted data obtained by combining all the data cut out by the plurality of temporal windows. The search process includes a fifth step (S145) of calculating an error between the relative frequency distribution in the target data and the relative frequency distribution in the extracted data. After executing the first step, the processing device 510 executes a search process in which the trials from the second step to the fifth step are repeatedly executed by changing the settings of a plurality of time windows. Then, the processing device 510 extracts the extracted data in which the error is equal to or less than the threshold (S150: YES). The processing device 510 calculates the index using the extracted data whose error becomes equal to or smaller than the threshold and the data of the initial prescribed period P0 (S160).

According to the data center 500, it is possible to obtain extracted data in which features of original data including a plurality of feature amounts are captured. Therefore, the data center 500 can calculate the index value with the same accuracy as in the case of using the original data by using the extracted data having a smaller data amount than the original data.

### Effect of this Embodiment

(1) According to the data center 500 that is the information processing device of the present embodiment, it is possible to achieve both reduction in the amount of data and calculation accuracy of the index value.

(2) According to the data center 500 which is the information processing device of the present embodiment, it is possible to calculate the index value in a shorter time than in the case where the original data is used.

(3) The processing device 510 sets, as target data, data obtained by excluding initial data having different tendencies of data from the original data. The processing device 510 executes clustering, which is machine learning for classifying the data of the sections obtained by dividing the target data into a predetermined number of clusters at regular intervals (S110). Then, in the second step (S125) of the search process, the processing device 510 sets a plurality of time-windows such that the difference between the ratio of each cluster in the extracted data and the ratio of each cluster in the entire target data is equal to or less than the threshold.

A plurality of sections classified into the same cluster are sections having similar characteristics. In the above-described search process, the setting output from the processing device 510 is a setting in which the difference between the ratio of the entire target data and each cluster is equal to or smaller than the threshold value, and the extracted data having the relative frequency distribution of each feature amount close to each other can be extracted.

Therefore, according to the search process executed by the data center 500, it is possible to find a setting that can obtain extracted data closer to the feature of the original data.

(4) The processing device 510 calculates an index value indicating the magnitude of the damage accumulated in the oil filter by using the extracted data in which the error becomes equal to or smaller than the threshold value and the data of the initial prescribed period P0. Therefore, it is possible to accurately calculate the index value even if the tendency of the data is different between the initial prescribed period P0 and the subsequent object period P1.

(5) The processing device 510 terminates the search process when one piece of extracted data whose error becomes equal to or smaller than the threshold value can be extracted, and calculates an index value using the extracted data whose error becomes equal to or smaller than the threshold value. Therefore, the data center 500 can calculate an index value at a time point when one piece of extracted data whose error becomes equal to or smaller than the threshold value can be extracted, and output the result promptly.

(6) When the calculated index value is equal to or greater than the predetermined value (S170: YES), the processing device 510 notifies that a failure has been predicted. Therefore, the data center 500 can notify the user that the occurrence of the failure has been predicted before the failure occurs.

(7) The processing device 510 calculates the damage degree Sh as an index. Therefore, the data center 500 can inform the user of how long the delay until the failure is reached.

(8) The processing device 510 predicts the life of the oil filter 36 from the slope of the transition of the index value in the object period P1. Therefore, the data center 500 can predict the life of the oil filter 36 according to the state of the transition of the index value.

### Example of Change

The present embodiment can be modified and implemented as follows. The present embodiment and modification examples described below may be carried out in combination of each other within a technically consistent range.
As the characteristic quantity, the flow rate of the oil passing through the oil filter 36 for which the index value of the damage is to be calculated and the speed change frequency of the automatic transmission 30 are exemplified. The feature amount is not limited to this, and may include an engagement frequency of a clutch that can be connected so that the power of the engine 20 can be transmitted to the automatic transmission 30, or that can disconnect the engine 20 from the automatic transmission 30. The characteristic quantity may include an engagement frequency of the friction engagement element in the friction engagement device 31. The characteristic quantity may include an engagement time of the frictional engagement element in the friction engagement device 31. The feature may include an engagement time of the lock-up clutch. The characteristic quantity may include a learned value of the shift control by the transmission control device 50.
In the above embodiment, an example in which the information processing device is embodied as the data center 500 has been described. An example in which the index value is calculated in the data center 500 has been described. On the other hand, the information processing device described above may be embodied as the information processing terminal 600. In this case, the calculation of the index value is executed by the processing device 610 of the information processing terminal 600. The above-described information processing device may be embodied as a control device of the vehicle 10. In this case, the calculation of the index value can also be performed by the control device of the vehicle 10. For example, the calculation of the index value may be performed by the transmission control device 50 of the vehicle 10.
In the above-described embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.
In the above-described embodiment, an example has been described in which, when the index value is equal to or larger than a predetermined value, it is notified that the occurrence of a failure has been predicted. This may be omitted. After the index value is calculated, only S190 process may be executed, and only the index value may be outputted.
Although the damage degree Sh is exemplified as the index value to be calculated, the index value to be calculated is not limited to the damage degree Sh.
The index value of the damage of the plurality of oil filters 36 may be calculated. The relative frequency distributions of the respective feature quantities of the oil filters 36 may be calculated, and the cut-out pattern may be searched so that the error of the relative frequency distributions of all the feature quantities becomes small.
For each oil filter 36, the cut-out pattern may be searched so that the relative frequency distribution becomes smaller with respect to the feature amount. The index value may be calculated for each oil filter 36.
The present disclosure can also be applied to a transmission including an oil filter 36 other than the automatic transmission 30 described in the above embodiments, such as a stepped automatic transmission mounted on a hybrid electric vehicle, a forward/reverse switching mechanism of a continuously variable transmission, and a clutch of a manual transmission.
The processing device 510 sets a plurality of time windows such that a difference between a ratio of each cluster in the target data and a ratio of each cluster in the extracted data is equal to or smaller than a threshold value. Without such a restriction, the processing device 510 may set a plurality of time windows. In such cases, the S110 process clustering may be omitted.
The method of determining the setting of the time window in the cut-out pattern may not be random. The trial may be repeated by changing the setting of the time window in the clipping pattern according to a preset rule.
The error calculated in S145 process is not limited to the mean absolute error MAE. For example, the processing device 510 may calculate a mean square error as an error. The processing device 510 may calculate a root mean square error as an error.
An example using extracted data obtained by combining all extracted data is shown. On the other hand, some of the extracted data may be combined to create extracted data.

What is claimed is:

1. An information processing device that reduces an amount of data to be used for analysis by extracting a part of data from original data collected over a predetermined period using a plurality of sensors mounted on a vehicle, the information processing device comprising a processing device that executes a process, wherein:
the processing device executes a search process including
a first step of calculating relative frequency distribution in object data obtained by excluding data for an initial prescribed period from the original data about a plurality of feature quantities included in the original data for each feature quantity,
a second step of setting a plurality of time windows for cutting out data for a part of a period of the object data such that a period obtained by totaling periods of all the time windows is shorter than an object period obtained by excluding the initial prescribed period from the predetermined period,
a third step of cutting out data from the object data using the time windows,
a fourth step of calculating relative frequency distribution in extracted data obtained by combining the data cut out using the time windows for each feature quantity, and
a fifth step of calculating an error between the relative frequency distribution in the object data and the relative frequency distribution in the extracted data; and
the processing device extracts the extracted data whose error is equal to or less than a threshold by executing the first step and thereafter repeatedly making trials to execute the second step to the fifth step while changing settings of the time windows.

2. The information processing device according to claim 1, wherein:
the processing device executes clustering that is machine learning to classify data in sections obtained by dividing the object data for each certain period into a predetermined number of clusters; and
the processing device sets the time windows in the second step such that a difference between a ratio of each cluster in the extracted data and a ratio of each cluster in the entire object data is equal to or less than a threshold.

3. The information processing device according to claim 1, wherein:
the original data include data on a flow rate of oil that passes through an oil filter as the feature quantity; and
the processing device calculates an index value that indicates a magnitude of damage accumulated in the oil filter using the extracted data whose error is equal to or less than the threshold and the data for the initial prescribed period.

4. The information processing device according to claim 3, wherein:
the oil is oil for a transmission; and
the original data include at least one of an engagement frequency and an engagement time of an engagement element of the transmission as the feature quantity.

5. The information processing device according to claim 3, wherein the processing device calculates the index value for each prescribed period, and predicts a life of the oil filter from a slope of transition of the index value.
